(19) United States
(12) Patent Application Publication
(10) Pub. No.: US 2020/0010030 A1
(43) Pub. Date: Jan. 9, 2020

(54) VEHICLE WHEEL

(71) Applicant: HONDA MOTOR CO., LTD., Tokyo (JP)

(72) Inventors: Youichi KAMIYAMA, Wako-shi (JP); Toshinobu SAITO, Wako-shi (JP); Yusuke OSAWA, Wako-shi (JP)

(21) Appl. No.: 16/502,362

(22) Filed: Jul. 3, 2019

(30) Foreign Application Priority Data
Jul. 6, 2018 (JP) 2018-129228

(51) Int. Cl. B60R 13/08; B60B 21/12; G10K 11/178

(52) U.S. Cl. CPC B60R 13/0884; B60B 21/12; G10K 2210/32272; B60B 2900/133; G10K 11/178

(57) ABSTRACT

Provided is a vehicle wheel with a sub-air chamber member as a Helmholtz resonator attached to a rim. The sub-air chamber member includes a main body having a sub-air chamber therein, a tubular body providing communication between the sub-air chamber and a tire air chamber, and a cover member covering the main body. The main body is disposed on a rim inner circumferential surface portion of the rim present on an inner side of the rim in a wheel radial direction and extending in a wheel width direction. The tubular body is disposed in a through-hole provided in the rim so as to provide communication between the inner side of the rim in the wheel radial direction and the tire air chamber side. The cover member covers the main body from an inner side in the wheel radial direction.

### BACKGROUND OF THE INVENTION

### 1. Field of the Invention

The present invention relates to a vehicle wheel.

### 2. Description of the Related Art

Conventionally, a wheel has been known which includes Helmholtz resonators (sub-air chamber members) that are attached to the outer circumferential surface of a well portion to silence air column resonance sound in a tire air chamber (see Japanese Patent No. 4551422, for example). Each sub-air chamber member of this wheel includes a main body having a sub-air chamber therein and formed elongated in the wheel circumferential direction, and a pair of plate-shaped edge portions extending outward in the wheel width direction from the sides of the main body over the entire length thereof in the longitudinal direction. Further, the sub-air chamber member is attached to the well portion by fitting the extending ends of the edge portions into grooves formed in the well portion.

### SUMMARY OF THE INVENTION

Meanwhile, in such a wheel, centrifugal force is exerted in such a direction as to detach the sub-air chamber members from the well portion during wheel rotation.

Thus, for such a wheel, a configuration capable of further improving the holdability of the sub-air chamber members on the rim is desirable.

An object of the present invention is to provide a vehicle wheel capable of enhancing the holdability of a sub-air chamber member on a rim as compared to conventional vehicle wheels.

A vehicle wheel of the present invention achieving the above object is a vehicle wheel with a sub-air chamber member as a Helmholtz resonator attached to a rim. The sub-air chamber member includes a main body having a sub-air chamber therein, a tubular body providing communication between the sub-air chamber and a tire air chamber, and a cover member covering the main body. The main body is disposed on a rim inner circumferential surface portion of the rim present on an inner side of the rim in a wheel radial direction and extending in a wheel width direction. The tubular body is disposed in a through-hole provided in the rim so as to provide communication between the inner side of the rim in the wheel radial direction and the tire air chamber side. The cover member covers the main body from an inner side in the wheel radial direction.

According to the present invention, it is possible to provide a vehicle wheel capable of enhancing the holdability of a sub-air chamber member on a rim as compared to conventional vehicle wheels.

### BRIEF DESCRIPTION OF THE DRAWINGS

FIG. 1 is a partially cutaway perspective view of a vehicle wheel according to an embodiment of the present invention.

FIG. 2 is a cross-sectional view taken along line II-II of FIG. 1.

FIG. 3 is an exploded perspective view of a sub-air chamber member.

FIG. 4 is a cross-sectional view of a sub-air chamber member according to a modification.

### DETAILED DESCRIPTION OF THE EMBODIMENTS

Next, a vehicle wheel according to an embodiment of the present invention will be described in detail with reference to drawings as appropriate. Note that in the drawings to be referred to, “X” indicates the wheel circumferential direction, “Y” indicates the wheel width direction, and “Z” indicates the wheel radial direction. In the following, the configuration of the whole vehicle wheel will be described first and then a sub-air chamber member as a Helmholtz resonator will be described.

### <Configuration of Whole Vehicle Wheel>

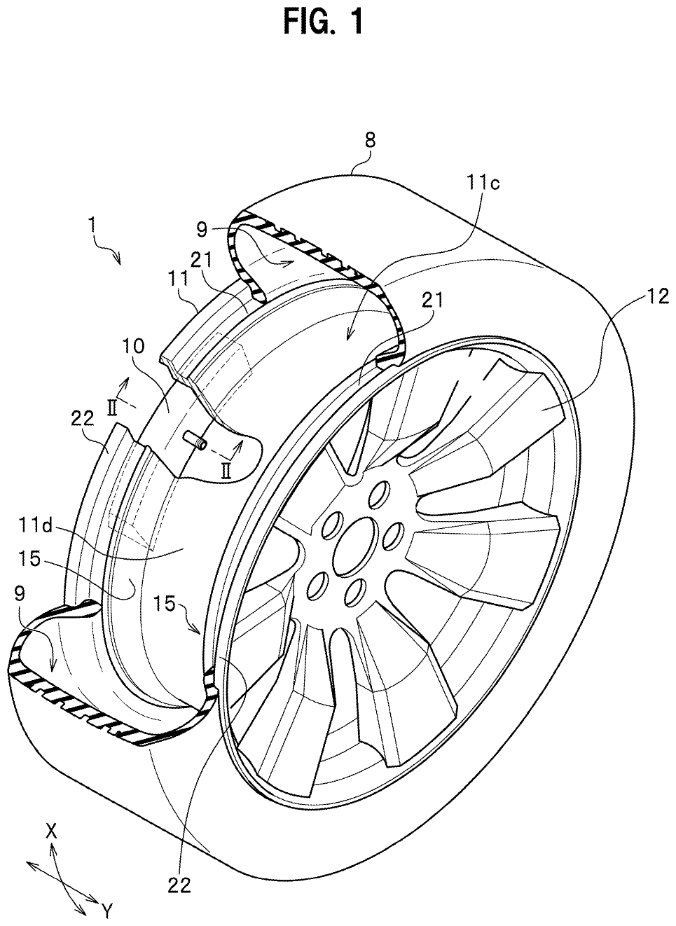

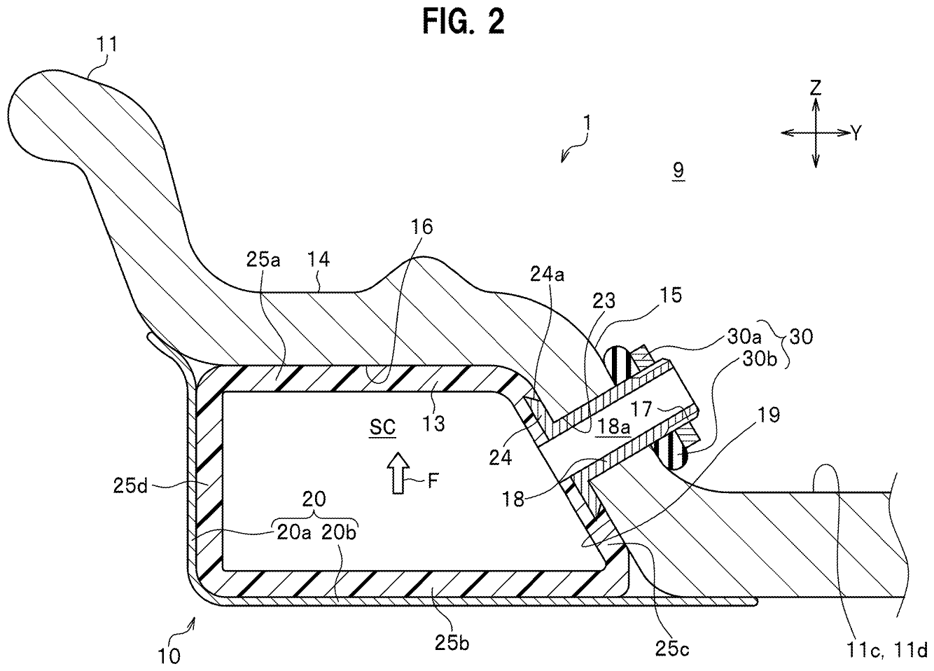

FIG. 1 is a partially cutaway perspective view of a vehicle wheel 1 according to an embodiment of the present invention. In FIG. 1, a tire 8 and a rim 11 are partially cut away. FIG. 2 is a cross-sectional view taken along line II-II of FIG. 1.

The vehicle wheel 1 according to this embodiment is assumed to be made of, for example, an alloy of a light metal such as aluminum or magnesium.

As shown in FIG. 1, the rim 11 has a well portion 11c recessed toward the wheel axis in the wheel radial direction between bead seats 21 formed at opposite end portions in the wheel width direction Y. An outer circumferential surface 11d of the well portion 11c defined by the bottom surface of this recess has a substantially constant diameter in the wheel width direction Y about the wheel axis. A tire air chamber 9 is formed between this outer circumferential surface 11d of the well portion 11c and the tire 8.

Note that reference sign 12 denotes a disc that couples the rim 11 to a hub not illustrated.

The rim 11 includes a pair of rising portions 15 rising toward rim flanges 22 from opposite end portions of the outer circumferential surface 11d of the well portion 11c in the wheel width direction Y. Also, the rim 11 rises further obliquely outward in the wheel radial direction to the rim flanges 22 from the rising portions 15 through the bead seats 21.

Moreover, the vehicle wheel 1 in this embodiment includes sub-air chamber members 10 attached as Helmholtz resonators to the rim 11 on its inner side in the vehicle width direction, i.e., the opposite side from the disc 12.

As shown in FIG. 2, the rim 11 on the inner side in the vehicle width direction (inner rim) has a rim inner circumferential surface portion 16 extending in the wheel width direction Y on the backside of one of the bead seats 14, i.e., on the inner side in the wheel radial direction Z.

The rim inner circumferential surface portion 16 in this embodiment extends substantially in parallel to the bead seat 14 in a cross-sectional view perpendicular to the wheel circumferential direction X (see FIG. 1). Meanwhile, though not illustrated, the bead seat 14 in this embodiment extends substantially in parallel to the wheel rotation axis. Also, the rim inner circumferential surface portion 16 extends annularly in the wheel circumferential direction X.

The rim 11 (inner rim) also has an inclined surface portion 19 extending substantially in parallel to the rising portion 15 on the back side of the rising portion 15, i.e., the inner side in the wheel radial direction Z. This inclined surface portion 19 extends annularly in the wheel circumferential direction X (see FIG. 1).

Also, in the rim 11, through-holes 23 are formed which penetrate through the rising portion 15 and the inclined surface portion 19. Each of these through-holes 23 extends in the direction perpendicular to the inclined surface portion 19.

Moreover, a main body 13 of each sub-air chamber member 10 to be described next is disposed along the rim inner circumferential surface portion 16 and the inclined surface portion 19.

### <Sub-Air Chamber Member>

As shown in FIG. 2, each sub-air chamber member 10 includes the main body 13, a tubular body 18, a cover member 20, and a fixing member 30.

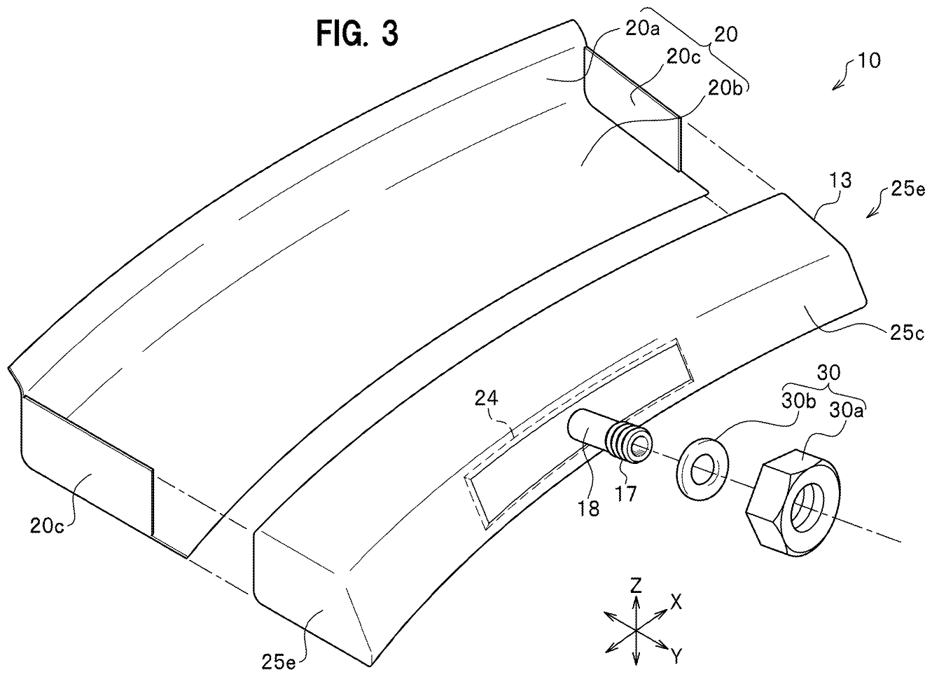

FIG. 3 is an exploded perspective view of the sub-air chamber member 10.

As shown in FIG. 3, the main body 13 is curved in its longitudinal direction. Specifically, the main body 13 is curved along the rim inner circumferential surface portion 16 (see FIG. 2) and the inclined surface portion 19 (see FIG. 2).

As shown in FIG. 2, the main body 13 defines a right-angled trapezoid elongated in the wheel width direction Y in a cross-sectional view perpendicular to the longitudinal direction (the wheel circumferential direction X in FIG. 1).

Specifically, the main body 13 has: a top plate 25a extending in the wheel width direction Y in abutment with the rim inner circumferential surface portion 16; a bottom plate 25b extending in parallel to the top plate 25a with a predetermined gap left therebetween; an inclined plate 25c extending in abutment with the inclined surface portion 19 and jointed to the top plate 25a and the bottom plate 25b; and a side plate 25d rising perpendicularly from the end of the bottom plate 25b opposite from the inclined plate 25c and joined to the top plate 25a.

The main body 13 also has a pair of end plates 25e disposed at the opposite ends in the wheel circumferential direction X, as shown in FIG. 3.

The top plate 25a (see FIG. 2), the bottom plate 25b (see FIG. 2), the inclined plate 25c (see FIG. 2), the side plate 25d (see FIG. 2), and the end plates 25e (see FIG. 3) form and surround a sub-air chamber SC (see FIG. 2) inside the main body 13.

Next, the tubular body 18 (see FIG. 2) will be described.

As shown in FIG. 2, a communication hole 18a is formed inside the tubular body 18.

The tubular body 18 is inserted in one of the through-holes 23, provided in the rim 11, from the inner side of the rim 11 to its outer side in the wheel radial direction Z.

Thus, the communication hole 18a provides communication between the sub-air chamber SC, formed inside the main body 13, and the tire air chamber 9.

As shown in FIG. 3, the tubular body 18 is formed substantially at the center of the main body 13 in the wheel circumferential direction X so as to protrude from the inclined plate 25c of the main body 13. The tubular body 18 protrudes in the direction perpendicular to the inclined plate 25c substantially from the center of the inclined plate 25c in the wheel radial direction Z.

At the distal end of the tubular body 18, a threaded portion 17 is formed on which to screw a nut 30a that is a component of the later-described fixing member 30.

The tubular body 18 also has a reinforcing member 24.

The reinforcing member 24 is formed of a plate body defining a narrow rectangular shape in a plan view. The reinforcing member 24 is disposed to extend in the wheel circumferential direction X along the inclined plate 25c and supports the proximal end of the tubular body 18 substantially at the center of the reinforcing member 24 in the wheel circumferential direction X.

As shown in FIG. 2, the sub-air chamber SC side of this reinforcing member 24 is joined to the inclined plate 25c. Specifically, the reinforcing member 24 is joined to the main body 13 so as to be half buried in the inclined plate 25c such that the outer surface of the reinforcing member 24 is exposed to the outside.

Also, a tapered portion 24a is formed at the (entire) outer periphery of the reinforcing member 24. This tapered portion 24a is inclined so as to widen from the outer side of the main body 13 toward the sub-air chamber SC. With this tapered portion 24a acting as wedges, the reinforcing member 24, half buried in the inclined plate 25c, is firmly joined to the inclined plate 25c.

Thus, the tubular body 18 is firmly attached to the main body 13 by the reinforcing member 24. Meanwhile, the tubular body 18 and the reinforcing member 24 in this embodiment are assumed to be a single molded body made of a metal and be attached to the main body 13 by insert molding.

Also, though not illustrated, the portion of the tubular body 18 in this embodiment to be positioned in the through-hole 23 of the rim 11 is coated with an elastic material such as rubber and press-fitted in the through-hole 23.

As shown in FIG. 3, the cover member 20 is formed of a bent plate body.

As shown in FIG. 2, the cover member 20 defines an L-shape in a cross-sectional view with a vertical wall 20a to be disposed in abutment with the side plate 25d of the main body 13 and a horizontal wall 20b to be disposed in abutment with the bottom plate 25b of the main body 13.

The outer edge of the vertical wall 20a in the wheel radial direction Z and the outer edge of the horizontal wall 20b extending toward the well portion 11c are each bonded to the surface of the rim 11. The method of joining the cover member 20 to the rim 11 is not limited to the above bonding but any joining method can be used.

As shown in FIG. 3, the cover member 20 also has a pair of side walls 20c at the opposite ends in the wheel circumferential direction X.

The side walls 20c are formed of substantially rectangular plate bodies connecting the vertical wall 20a and the horizontal wall 20b.

These side walls 20c are disposed in abutment with the end plates 25e of the main body 13 when the vertical wall 20a and the horizontal wall 20b are joined to the rim 11.

Next, the fixing member 30 (see FIG. 2) will be described.

As shown in FIG. 2, the fixing member 30 is configured to fix a distal end portion of the tubular body 18 projecting into the tire air chamber 9 to the rim 11 around the through-hole 23.

Specifically, the fixing member 30 is formed of the nut 30a to be screwed on the threaded portion 17 of the tubular body 18, and an O-ring 30b to be fitted on the tubular body 18 and interposed between the rim 11 and the nut 30a. Note that the O-ring 30b in this embodiment is assumed to be made of an elastic member such as rubber.

Though not illustrated, the above vehicle wheel 1 in this embodiment is assumed to be such that four sub-air chamber members 10 (see FIG. 1) are disposed at equal intervals in the wheel circumferential direction X. Also, the tubular bodies 18 forming the communication holes 18a to the respective sub-air chambers SC are disposed at 90-degree intervals about the wheel rotation axis. However, the number of sub-air chambers SC and the positions of the tubular bodies 18 are not limited to the above. Thus, when the number of sub-air chambers SC is two, their respective tubular bodies 18 can be disposed at positions 90 degrees apart about the wheel rotation axis. Also, when the number of sub-air chambers SC is three or more than four, their respective tubular bodies 18 can be disposed at equal intervals in the wheel circumferential direction X.

Next, advantageous effects achieved by the vehicle wheel 1 in this embodiment will be described.

In the vehicle wheel 1 in this embodiment, the sub-air chamber members 10 are disposed on the rim inner circumferential surface portion 16, which extends in the wheel width direction Y, on the inner side of the rim 11 in the wheel radial direction Z.

In this vehicle wheel 1, when a centrifugal force F (see FIG. 2) is exerted on the main bodies 13 of the sub-air chamber members 10 during wheel rotation, the rim inner circumferential surface portion 16 holds the main bodies 13 against the centrifugal force F.

With this vehicle wheel 1, the holdability of the main bodies 13 on the rim 11 is enhanced as compared to conventional vehicle wheels.

Also, in the vehicle wheel 1, the tubular bodies 18, provided to the main bodies 13, are inserted in the through-holes 23, provided in the rim 11.

Thus, with the vehicle wheel 1, the holdability of the main bodies 13 on the rim 11 is further enhanced by the tubular bodies 18.

Also, in the vehicle wheel 1, the cover members 20 cover the main bodies 13 from the inner side in the wheel radial direction Z, thereby preventing chipping, contamination, and damage of the main bodies 13.

Also, the vehicle wheel 1 has the fixing members 30, which hermetically fix the tubular bodies 18 to the rim 11 around the through-holes 23.

With this vehicle wheel 1, the holdability of the main bodies 13 on the rim 11 with the tubular bodies 18 is further improved, and the airtightness around the through-holes 23 is further improved as well.

Although this embodiment has been described above, the present invention is not limited to the above embodiment but can be carried out in various ways.

Each sub-air chamber member 10 in the above embodiment is assumed to be such that the main body 13 and the cover member 20 are separate bodies. However, each sub-air chamber member 10 can be configured such that the main body 13 and the cover member 20 are formed as a single body in advance.

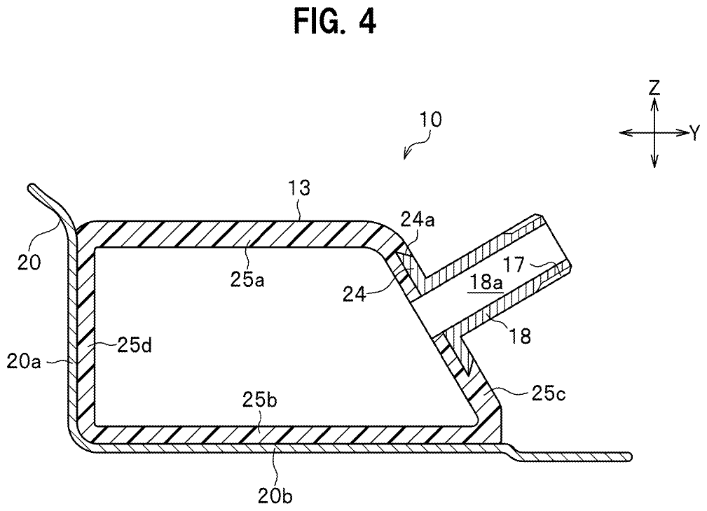

FIG. 4 is a cross-sectional view of the sub-air chamber member 10 according to a modification. Note that constituent components in FIG. 4 similar to those in the above embodiment are denoted by identical reference signs, and detailed description thereof is omitted.

As shown in FIG. 4, the vertical wall 20a and the horizontal wall 20b of each cover member 20 are welded to the side plate 25d and the bottom plate 25b of the corresponding main body 13, respectively. Also, though not illustrated, the side walls 20c (see FIG. 3) are welded to the end plates 25e (see FIG. 3) as well.

In other words, the cover member 20 is formed integrally with the main body 13 such that the surface of the cover member 20 itself forms the surface of the main body 13.

This single body formed of the cover member 20 and the main body 13 can be obtained by insert-molding performed with the cover member 20 placed in advance in a predetermined mold.

In the vehicle wheel 1 having the sub-air chamber member 10 according to this modification, the main body 13 and the cover member 20 are formed integrally with each other, thus making it easier to mount the sub-air chamber member 10 to the rim 11.

Also, the mechanical strength of the main body 13 is further improved by the cover member 20.

What is claimed is:

1. A vehicle wheel with a sub-air chamber member as a Helmholtz resonator attached to a rim, wherein
the sub-air chamber member comprises
a main body having a sub-air chamber therein,
a tubular body providing communication between the sub-air chamber and a tire air chamber, and
a cover member covering the main body,
the main body is disposed on a rim inner circumferential surface portion of the rim present on an inner side of the rim in a wheel radial direction and extending in a wheel width direction,
the tubular body is disposed in a through-hole provided in the rim so as to provide communication between the inner side of the rim in the wheel radial direction and the tire air chamber side, and
the cover member covers the main body from an inner side in the wheel radial direction.

2. The vehicle wheel according to claim 1, wherein the sub-air chamber member further comprises a fixing member hermetically fixing the tubular body to the rim around the through-hole.

3. The vehicle wheel according to claim 1, wherein the cover member is attached to the main body by insert molding.
